(19) United States
(12) Patent Application Publication
(10) Pub. No.: US 2026/0010860 A1
(43) Pub. Date: Jan. 8, 2026

(54) OPTIMIZING ENTERPRISE TECHNOLOGY ECOSYSTEMS USING ARTIFICIAL INTELLIGENCE TO ANALYZE DATA, PREDICT STABILITY, IDENTIFY DEPENDENCIES, AND GENERATE ACTIONABLE TASKS

(71) Applicant: TEACHERS INSURANCE AND ANNUITY ASSOCIATION OF AMERICA, New York, NY (US)

(72) Inventors: Sastry VSM Durvasula, Phoenix, AZ (US); Swatee Singh, Livingston, NJ (US); Rares Ioan Almasan, Paradise Valley, AZ (US); Thomas Matthew Verutes, Rockville Centre, NY (US); Sriram Venkatesan, Princeton Junction, NJ (US); Sonam Jha, Skillman, NJ (US)

(21) Appl. No.: 18/764,861

(22) Filed: Jul. 5, 2024

(51) Int. Cl. G06F 16/23

(52) U.S. Cl. CPC G06Q 10/067

(57) ABSTRACT

A computing system includes a processor and memory with instructions to collect data, apply artificial intelligence for analysis, identify dependencies, generate tasks, update sources in real-time, and maintain equilibrium across an enterprise technology ecosystem. A method and a computer-readable medium are also provided for performing these functions.

### FIELD OF THE INVENTION

The present aspects relate to computing systems for optimizing enterprise technology ecosystems, and more particularly, to systems and methods that apply artificial intelligence to analyze data across various layers, such as generating actionable tasks to maintain equilibrium and optimize processes.

### BACKGROUND

In the realm of enterprise technology ecosystems, the challenge of managing complex interdependencies and ensuring efficient process flows has been a persistent issue. Enterprises often struggle with siloed teams that lack visibility into the work and dependencies of other teams, leading to delays, technical debt, and duplication of efforts. This fragmentation can impede the timely delivery of projects and result in significant financial losses. The use of traditional tools and methodologies, including various management platforms and agile methodologies, has been a common approach to address these challenges. However, these tools often fall short in providing a comprehensive and dynamic understanding of the intricate relationships and dependencies within the technology stack and architecture.

Moreover, the current landscape of enterprise technology involves managing a diverse array of infrastructure components, including cloud and hybrid environments, which adds another layer of complexity. The demand for real-time data integration and the need to leverage artificial intelligence for predictive analysis and decision-making underscore the limitations of existing systems. Traditional artificial intelligence (AI) and artificial neural network (ANN) applications have been focused on forecasting and identifying cross-platform dependencies, yet there remains a gap in effectively translating these insights into actionable and optimized tasks. Additionally, the governance of technology assets and the management of risk highlight the need for more sophisticated solutions that can navigate the multifaceted nature of enterprise ecosystems. Given these challenges, there are clear opportunities for improved platforms and technologies that can address these conventional problems.

### BRIEF SUMMARY OF THE INVENTION

In one aspect, a computing system includes: (1) a processor and (2) a memory that includes computer-executable instructions that, when executed, cause the computing system to collect data from various layers of an enterprise technology ecosystem, apply artificial intelligence to analyze the collected data to generate relationships and predict stability across the layers, identify dependencies, and generate actionable tasks to optimize processes, wherein the system updates sources in real-time based on event-triggered updates and maintains equilibrium across all layers by recommending actionable tasks to maintain said equilibrium.

In another aspect, a computer-implemented method for optimizing enterprise technology ecosystems includes: (1) collecting data from various layers of an enterprise technology ecosystem; (2) applying artificial intelligence to analyze the collected data to generate relationships and predict stability across the layers; (3) identifying dependencies; (4) generating actionable tasks to optimize processes; (5) updating sources in real-time based on event-triggered updates; and (6) maintaining equilibrium across all layers by recommending actionable tasks to maintain said equilibrium.

In yet another aspect, a computer-readable medium includes instructions that when executed cause a computer to perform: (1) collecting data from various layers of an enterprise technology ecosystem; (2) applying artificial intelligence to analyze the collected data to generate relationships and predict stability across the layers; (3) identifying dependencies; (4) generating actionable tasks to optimize processes; (5) updating sources in real-time based on event-triggered updates; and (6) maintaining equilibrium across all layers by recommending actionable tasks to maintain said equilibrium.

### BRIEF DESCRIPTION OF THE DRAWINGS

FIG. 1 depicts a computing environment including a layer stability computing system for collecting data from various layers of an enterprise technology ecosystem, according to some aspects.

FIG. 2 depicts a computer-implemented method for optimizing processes within an enterprise technology ecosystem by leveraging artificial intelligence (AI) to analyze data across various layers, predict stability, identify dependencies, and generate actionable tasks, according to some aspects.

FIG. 3 depicts a block flow diagram of an action pulse navigator for managing and supporting technological functions, according to some aspects.

FIG. 4 depicts a block flow diagram of the planning and management platform of FIG. 3 for managing and supporting technological functions, according to some aspects.

FIG. 5 depicts a block flow diagram of the Infrastructure Ecosystem of FIG. 3, according to some aspects.

FIG. 6 depicts a block flow diagram for the operation and functionality of a Prognosis Console within a computing environment, according to some aspects.

FIG. 7 depicts a block flow diagram for generating various output components of an Action Board, according to some aspects.

FIG. 8 depicts a block flow diagram of an exemplary architectural diagram depicting a computing architecture, according to some aspects.

### DETAILED DESCRIPTION

The detailed description that follows is directed to, inter alia, techniques for enhancing the efficiency and stability of enterprise technology ecosystems through the application of artificial intelligence (AI). The present techniques are address challenges faced by organizations in managing complex technology stacks and the interdependencies between different layers of their enterprise architecture. In the rapidly evolving landscape of enterprise technology, organizations face the challenge of managing complex technical stacks and architecture ecosystems. These ecosystems comprise a myriad of components, including infrastructure, applications, and data layers, each with its own set of dependencies and interactions. The traditional approach to managing these ecosystems often results in siloed teams, unclear dependencies, and a lack of holistic understanding of the enterprise's technological landscape. This, in turn, leads to delays in project deliveries, technical debt, duplication of efforts, and significant financial losses. To address these challenges, the present techniques may leverage AI to provide a comprehensive solution.

The present techniques and modeling may collect data from a plurality of layers of an enterprise's technology ecosystem to gain a holistic perspective of the enterprise's applications, dependencies, and progress. By applying AI to this data, the system can generate relationships and predict stability across all layers, identifying dependencies and recommending actionable tasks to optimize processes. This approach may be used to ensure that sources are updated in real time with event-triggered updates, allowing for a dynamic response to changes within the ecosystem. The ability of the present techniques to maintain stability and equilibrium across all layers, coupled with its capacity to recommend actionable tasks, significantly improve enterprise technology ecosystems. By collecting data across various layers of an enterprise's technology ecosystem, the system applies AI to analyze this data, generating insights into relationships and predicting stability across these layers. This approach not only identifies dependencies but also generates actionable tasks aimed at optimizing processes, thereby improving the overall performance and reliability of the technology ecosystem.

One of the significant improvements this system introduces is in the realm of processing efficiency. By leveraging AI to analyze collected data, the system can swiftly identify patterns, dependencies, and potential issues within the technology stack. This capability allows for the generation of actionable tasks that can preemptively address problems before they impact the system's stability. The real-time update feature, triggered by event-based updates, ensures that the system's data sources are current, further enhancing the system's ability to respond quickly to changes and maintain equilibrium across a plurality of layers. By utilizing AI, specifically neural networks and other AI models, the system can efficiently process vast amounts of data from various sources within the enterprise's technology ecosystem. This processing capability allows for accurate forecasting of work volumes, identification of cross-platform and cross-program dependencies, and tracking of completion statuses. The system's AI-driven analysis not only streamlines data processing but also enables more informed decision-making by providing insights into the enterprise's technological landscape.

The ability of the present techniques to operate autonomously, taking proactive, reactive, and prescriptive actions, represents a significant advancement in enterprise technology ecosystem design and development. This autonomy, supported by the incorporation of feedback from users on automated actions, allows the present techniques to continuously improve performance and effectiveness. The management of a dependency map that includes service level agreements (SLAs) for various components further enhances the system's ability to maintain stability and optimize processes across the technology ecosystem.

Further, the integration with management platforms for agile project management, such as tools like Jira, enables a more cohesive and efficient approach to project execution and team collaboration. This integration ensures that actionable tasks generated by the system are effectively communicated and executed, further enhancing the ability of the present techniques to maintain equilibrium and optimize processes across the enterprise technology ecosystem. This optimized network usage facilitates better coordination among teams, reduces redundancy, and enhances the overall efficiency of the enterprise's operations. By maintaining a continuous flow of updated information, the system helps prevent bottlenecks and ensures that all components of the technology ecosystem are aligned and functioning cohesively.

Furthermore, by employing clustering techniques and a data mesh architecture, the system can effectively organize and interpret vast datasets, enabling more efficient storage and retrieval of information. This optimized memory usage is crucial for managing the complex data layers within an enterprise's technology ecosystem, ensuring that data is accessible and actionable.

In summary, the present AI-enabled enterprise technical stack and architecture ecosystem improve upon conventional technology ecosystems by applying AI to analyze data across various layers, generating actionable insights that improve processing efficiency, optimize network and memory usage, and enhance overall system stability. Through autonomous operation and integration with agile project management platforms, the present techniques offer a comprehensive solution to the challenges of tending to complex technology stacks and the interdependencies between different layers of enterprise architecture. By leveraging AI to enhance processing capabilities, optimize network usage, and improve memory usage, the system offers a comprehensive approach to achieving efficiency, stability, and equilibrium across all layers of the enterprise's technology ecosystem. These improvements not only address the immediate challenges of siloed teams and unclear dependencies but also pave the way for more agile, responsive, and financially sound enterprise operations.

### Computing Environment

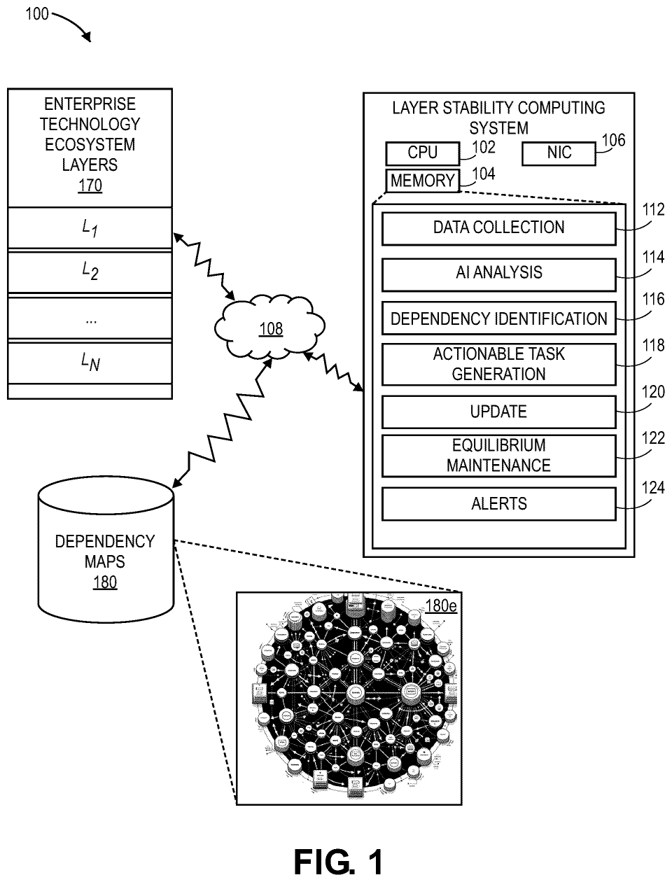

FIG. 1 depicts a computing environment including a layer stability computing system 100 for collecting data from various layers of an enterprise technology ecosystem, applying artificial intelligence to analyze the collected data to generate relationships and predict stability across the layers, identifying dependencies, and generating actionable tasks to optimize processes.

In some aspects, layer stability computing system 100 includes a processor 102, a memory 104, and a network interface controller (NIC) 106. The computing system 100 may be designed to collect data from a plurality of layers 170 of an enterprise technology ecosystem, apply artificial intelligence to analyze the collected data to generate relationships and predict stability across the layers, identify dependencies, and generate actionable tasks to optimize processes. The dependencies may be stored in a dependency maps database 180.

In general, the layer stability computing system 100 may update sources in real-time based on event-triggered updates and maintain equilibrium across all layers by generating recommended actionable tasks to maintain equilibrium. The processor 102 may include one or more CPUs, one or more GPUs, etc. The processor 102 executes computer-executable instructions. The memory 104 may include a random-access memory (RAM), a read-only memory (ROM), a hard disk drive (HDD), a magnetic storage, a flash memory, a solid-state drive (SSD), and/or one or more other suitable types of volatile or non-volatile memory. The memory 104 stores computer-executable instructions that the processor 102 executes.

The memory 104 includes a plurality of modules, each including a respective set of computer-executable instructions. For example, a data collection module 112 collects data from the plurality of layers 170 of the enterprise technology ecosystem. An AI analysis module 114 applies artificial intelligence to analyze the collected data to generate relationships and predict stability across the layers. A dependency identification module 116 identifies dependencies within the ecosystem. An actionable task generation module 118 generates actionable tasks to optimize processes based on the analysis. An update module 120 updates sources in real-time based on event-triggered updates. An equilibrium maintenance module 122 maintains equilibrium across all layers by recommending actionable tasks. An alert module 124 triggers alerts to a planning and execution team for each layer when actionable tasks are identified. The functionality of each of these modules supports operations across the computing environment of FIG. 1.

The layer stability computing system 100 includes a network interface controller (NIC) 106, enabling communication with external data sources, customer interfaces, and other systems necessary for the autonomous contact center's operation. The NIC 106 enables the layer stability computing system 100 to access other devices (e.g., a client computing device 170, a database 180, etc.) via an electronic network 108. The network 108 may include the Internet and/or another suitable network (e.g., a local area network (LAN), a metropolitan area network (MAN), a wide area network (WAN), a mobile, a wired or wireless network, a virtual private network (VPN), etc.).

The data collection module 112, for instance, interacts with the processor 102 to collect data from various layers of the enterprise technology ecosystem. The AI analysis module 114 uses the processor 102 to apply artificial intelligence techniques to the collected data, generating insights into relationships and predicting stability across the layers. The dependency identification module 116 works in conjunction with the AI analysis module 114 to identify dependencies within the ecosystem. The actionable task generation module 118, based on the analysis and identified dependencies, generates actionable tasks to optimize processes. The update module 120 ensures that all sources are updated in real-time based on event-triggered updates. Herein, the term “real-time” refers to the ability of the system 100 to process data and provide outputs almost instantaneously or within a very short time from receiving data. This is contrasted with batch processing, wherein some period of delay or periodicity is introduced for the processing of data. Real-time may refer to a situation in which a very small delay is used (e.g., 0.1 second, such that the delay is imperceptible to humans).

The equilibrium maintenance module 122 recommends actionable tasks to maintain equilibrium across all layers. The alert module 124, in response to identified actionable tasks, triggers alerts to the planning and execution team for each layer, ensuring timely action and optimization.

The plurality of layers 170 may include a first layer L1, a second layer L2 up to LN layers, where N is any positive integer. Example layers may include a digital, client facing layer, one or more API layers, one or more business or product layers, one or more application layers, one or more platform layers, one or more tooling layers, one or more cybersecurity layers, one or more blockchain layers, one or more AI model layers, etc. Layers are discussed in additional detail, below.

The dependency maps database 180 may include one or more graphs or maps representing one or more network ecosystems. The graphs may include a plurality of nodes connected by zero or more edges to other nodes (or not connected to other nodes, in the case of zero edges), as depicted in example dependency map 180e. The dependency maps database 180 may be used to determine task dependencies between a plurality of systems maintained by different development teams that do not have explicit knowledge of one another.

The database 170 may encompass various types and forms of data storage systems, including but not limited to relational databases, NoSQL databases, in-memory databases, cloud databases, distributed databases, object-oriented databases, graph databases, and time-series databases. Examples of relational databases include MySQL, PostgreSQL, Oracle Database, and Microsoft SQL Server, which are designed for structured data storage and support SQL for data manipulation. NoSQL databases, such as MongoDB, Cassandra, Couchbase, and DynamoDB, cater to unstructured or semi-structured data, offering flexibility in data models and scalability. In-memory databases like Redis and Memcached provide high-performance data access by storing data in the main memory. Cloud databases, including Amazon RDS, Google Cloud SQL, and Microsoft Azure SQL Database, offer database services hosted in the cloud, ensuring scalability, high availability, and managed services. Distributed databases, such as CockroachDB and Google Spanner, are designed to run across multiple nodes or locations, ensuring data consistency and fault tolerance. Object-oriented databases, for instance, ObjectDB and db40, store data in the form of objects, as used in object-oriented programming. Graph databases, like Neo4j and Amazon Neptune, are optimized for storing and querying data that is interconnected, making them ideal for social networks, recommendation engines, and fraud detection. Time-series databases, such as InfluxDB and TimescaleDB, are specialized for handling time-stamped or time-series data, widely used in financial services, IoT, and monitoring systems. Each of these databases offers unique features and capabilities tailored to specific data storage, management, and retrieval needs, enabling efficient and effective handling of diverse data types and volumes across various applications and industries.

In operation, the layer stability computing system 100 may serve as an autonomous system that takes proactive, reactive, and prescriptive actions to prevent issues and maintain system equilibrium. The layer stability computing system 100 may operate by collecting data from various layers of an enterprise technology ecosystem, including infrastructure ecosystems like cloud, hybrid, and any device connected to other platforms. The layer stability computing system 100 may apply artificial intelligence to analyze the collected data, generating relationships and predicting stability across the layers. The layer stability computing system 100 may identify dependencies and generates actionable tasks to optimize processes, updating sources in real-time based on event-triggered updates. The layer stability computing system 100 may maintain equilibrium across a plurality of layers by recommending actionable tasks to maintain said equilibrium and triggers alerts to a planning and execution team for each layer when actionable tasks are identified. In some aspects, users can provide feedback on automated actions taken by the system, which the system incorporates in subsequent cycles of operation. The layer stability computing system 100 may manage a dependency map that includes service level agreements (SLAs) for various components of the technology ecosystem and interacts with infrastructure ecosystems, including cloud, hybrid, and any device connected to other platforms. The layer stability computing system 100 may integrate with management platforms for agile project management, ensuring a holistic perspective of enterprise application, dependencies, and progress.

### Computer-Implemented Method

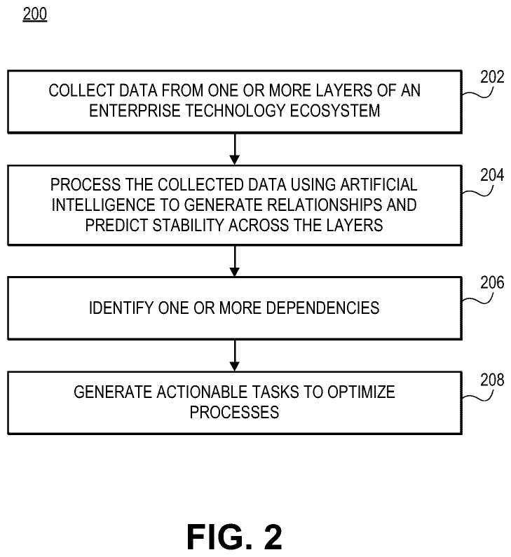

FIG. 2 depicts a computer-implemented method 200 for optimizing processes within an enterprise technology ecosystem by leveraging artificial intelligence (AI) to analyze data across various layers, predict stability, identify dependencies, and generate actionable tasks. This method 200 is designed to operate within a computing environment that includes a processor and a memory (e.g., the layer stability computing system 100) where the memory stores computer-executable instructions that, when executed by the processor, enable the computing system to perform the described method. The computing environment may be part of an AI-enabled enterprise technical stack and architecture ecosystem, designed to address the challenges of siloed team operations, unclear dependencies, and the resultant delays in project deliveries, technical debt, and duplication of work.

The method 200 may include collecting data from various layers of an enterprise technology ecosystem (block 202). This step involves gathering comprehensive data from all available layers within the enterprise's technology stack, including but not limited to infrastructure, applications, and services. The data collection is aimed at obtaining a holistic view of the enterprise's technological landscape, encompassing both the physical and virtual components. The computing environment responsible for this step may utilize various tools and platforms, such as cloud services, hybrid environments, and devices connected across platforms, to ensure a thorough data collection process.

Next, the method 200 may include applying artificial intelligence to analyze the collected data to generate relationships and predict stability across the layers (block 204). AI techniques, such as neural networks and/or other AI algorithms, may be employed to process the collected data, identifying patterns, forecasting work volumes, and predicting cross-platform and cross-program dependencies and relationships. This step enables understanding the intricate web of interactions within the technology ecosystem and for forecasting potential issues that may arise due to these dependencies.

The method 200 may further include identifying dependencies (block 206), where the AI-driven analysis helps pinpoint interdependencies among various components of the technology ecosystem. This step may leverage the insights generated at block 204 to map out the dependencies, which is essential for understanding how different layers and components are interconnected and how they impact one another. The method 200 may store these dependencies in the dependency maps database 180, in some aspects.

The method 200 may include generating actionable tasks to optimize processes (block 208). Based on the analysis (block 204) and the identified dependencies (block 206), the system may generate recommendations for actions that can be taken to improve efficiency and optimize processes within the technology ecosystem at block 208. These actionable tasks may be designed to address both known and unknown patterns, with the system providing next-best actions for maintaining or restoring equilibrium within the ecosystem.

The method 200 may include updating sources in real-time based on event-triggered updates. This step may enable the system to remain up-to-date with changes across the technology ecosystem, allowing for timely adjustments and interventions. Real-time updates further assist to maintain an accurate understanding of the state of the ecosystem and for enabling the system to respond promptly to emerging issues.

The method 200 may include maintaining equilibrium across one or more layers by recommending actionable tasks to maintain said equilibrium. This may involve continuously and/or periodically monitoring the technology ecosystem to ensure stability and balance across all layers. The method 200 may include recommending specific actions to be taken when imbalances are detected, thereby helping to prevent issues and maintain system equilibrium. This step may be supported by a feedback mechanism that allows users to provide input on the automated actions taken, ensuring that the system can learn and adapt over time.

The computing environment that performs the method 200 (e.g., the layer stability computing system 100) may interact with various components of the technology ecosystem, including infrastructure ecosystems (such as cloud and hybrid environments), management platforms (such as agile project management tools), and technology assets (such as CMDB components for governance). Additionally, the system may manage a dependency map that includes service level agreements (SLAs) for various components, ensuring that all actions and recommendations are aligned with the agreed-upon standards and expectations.

The method 200 and computing environment of FIG. 1 offer an improved solution for optimizing processes within an enterprise technology ecosystem. By leveraging AI to analyze data, predict stability, identify dependencies, and generate actionable tasks, the system 100 and method 200 address the challenges of siloed operations and unclear dependencies, ultimately leading to improved efficiency, reduced technical debt, and enhanced project delivery timelines.

### Block Flow Diagram—Action Pulse Navigator

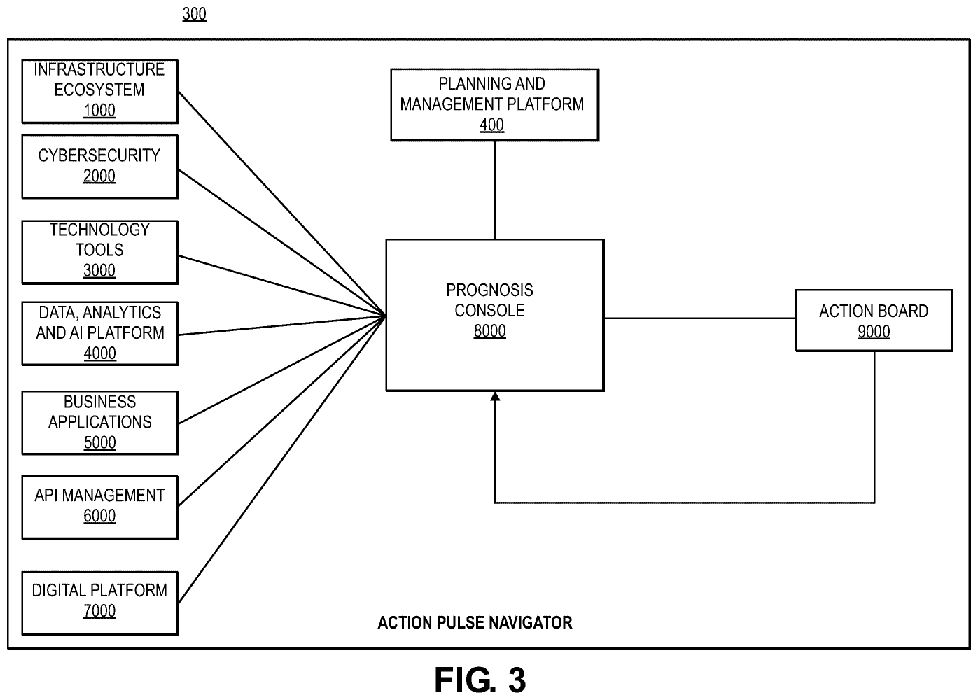

FIG. 3 depicts a block flow diagram of an action pulse navigator 300 for managing and supporting technological functions, with a focus on integrating data from various ecosystems through a central unit, the Prognosis Console, to facilitate planning, management, and actionable insights. The action pulse navigator 300 receive data from a planning and management platform (block 400). This data may originate from various agile or project management tools, such as Jira or Jira Align, providing insights into work progress, completion status, and overall project health.

The action pulse navigator 300 may interface with an Infrastructure Ecosystem (block 1000), where data regarding the organization's infrastructure is collected and analyzed. This may involve continuous or periodic monitoring and/or event-based alerts to ensure infrastructure reliability and performance.

The action pulse navigator 300 may integrate cybersecurity data (block 2000), where information related to security threats, vulnerabilities, and incidents is processed. This ensures that cybersecurity measures are continuously updated and aligned with the current threat landscape.

The action pulse navigator 300 may incorporate technology tools (block 3000), which may involve gathering data from various software and hardware tools used within the organization to enhance productivity and operational efficiency.

The action pulse navigator 300 may connect with a Data, Analytics & AI Platform (block 4000), where data is analyzed, and insights are generated using advanced analytics and artificial intelligence techniques. This enables data-driven decision-making across the organization.

The action pulse navigator 300 may link with Business Applications (block 5000), which involves integrating data from various business applications to provide a holistic view of organizational operations and performance.

The action pulse navigator 300 may facilitate API interactions (block 6000), where the system interfaces with various internal and external APIs to facilitate seamless data exchange and integration across different platforms and services.

The action pulse navigator 300 may integrate with a Digital Platform (block 7000), which may involve collecting and analyzing data from digital channels to enhance digital presence and customer engagement.

The action pulse navigator 300 may include bidirectional communication with other components (e.g., a feedback mechanism, providing actionable insights, dashboards, alerts, notifications, and events based on the data processed by the Prognosis Console 8000). This enables the system to not only monitors and analyzes data but also improve timely actions based on the insights generated.

For example, in the computing environment of FIG. 1, the Prognosis Console 8000 acts as the central control unit, orchestrating data flow and interactions between the various components (e.g., the modules of the memory 104). The Prognosis Console 8000 may integrate data from a planning and management platform 400, to provide a comprehensive view of project statuses and dependencies, leveraging both continuous data flow and event-based triggers to inform necessary actions. This integration enables the system to offer a dynamic and responsive management and support framework for technological functions within the organization.

### Block Flow Diagram—Planning and Management Platform

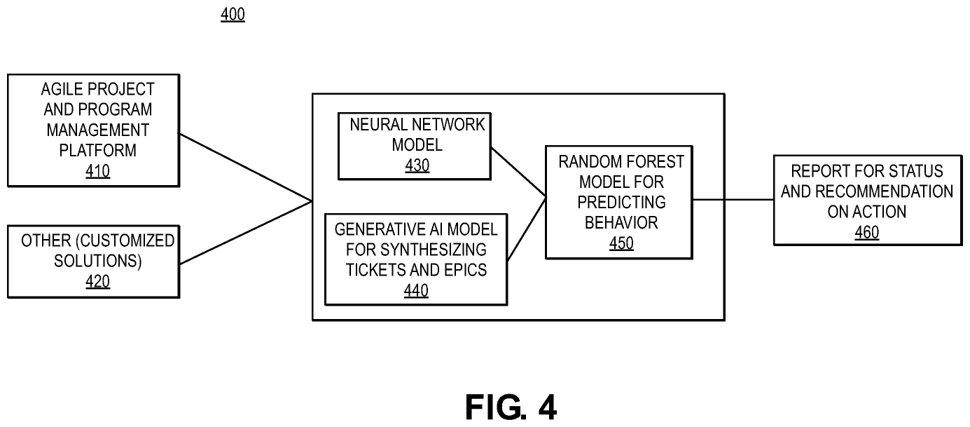

FIG. 4 depicts a block flow diagram of the planning and management platform 400 of FIG. 3 for managing and supporting technological functions with a focus on integrating various functional areas through a central control unit, the Prognosis Console 8000, and facilitating data flow and control signals between interconnected components. The planning and management platform 400 may enhance planning, management, and execution of technology-related tasks by leveraging AI and neural network models for predictive analysis and decision-making.

The planning and management platform 400 may receive inputs from an agile project and program management platform (block 410). The planning and management platform 400 may aggregate platform information from various sources, including Agile project and program management tools like Jira or Jira Align, customized solutions, and data stored in formats such as spreadsheets or SharePoint (block 420). The diversity of sources ensures comprehensive coverage of project and program management information.

The planning and management platform 400 may process inputs through a neural network or traditional AI models to predict and identify information related to work volume, cross-platform and program dependencies, and the completion status of tasks (block 430). The planning and management platform 400 may process the inputs from blocks 410 and 420 using one or more generative AI models to cluster problems and generate insights, facilitating the classification of dependencies and required actions for specific technological solutions, such as API security measures (block 440).

In some aspects, the planning and management platform 400 may generate reports based on the predicted volume of work and captured information, which are then used as inputs for further analysis. These reports may help in aligning priorities and planning for future workloads, ensuring that dependent teams can adjust their schedules and resources accordingly.

The planning and management platform 400 may provide recommendations for action based on known and unknown patterns of work processes (blocks 450-460). For example, the planning and management platform 400 may predict the scope of work for upcoming quarters and identifying new, previously unencountered challenges. The planning and management platform 400 may leverage past data and patterns to suggest actions, even for novel tasks, by recognizing similarities with previous projects. The planning and management platform 400 may use a random forest model for predicting behavior.

In the context of a computing environment, the planning and management platform 400 may be implemented on a server or cloud infrastructure, capable of integrating with various project management tools and data sources (e.g., the computing system 100 of FIG. 1). The neural network or AI models could run on specialized computing resources optimized for machine learning tasks, ensuring efficient processing and analysis of large datasets (e.g., Graphics Processing Units (GPUs) or other specialized hardware). The generation of reports and recommendations could be facilitated by a combination of software applications and AI algorithms, with outputs accessible through user interfaces on desktops or mobile devices.

Each aspect of the block flow diagram of planning and management platform 400 can be performed by specific components within the computing environment. For example, data aggregation and initial processing might be handled by a data management system, while predictive analysis and insight generation could be executed on a machine learning platform. The final step of generating actionable recommendations could involve both AI models and user interface components, ensuring that the insights are presented in an accessible and actionable format.

### Block Flow Diagram—Infrastructure Cloud Platform

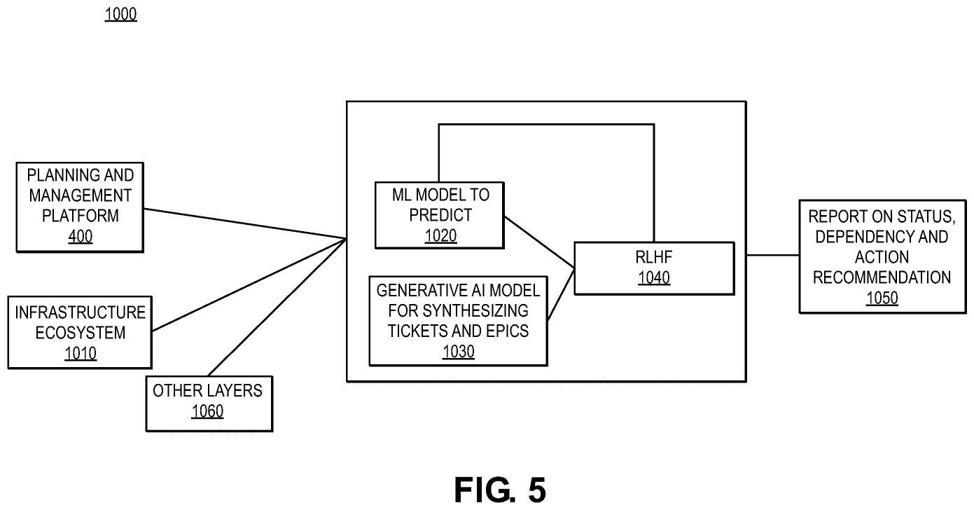

FIG. 5 depicts a block flow diagram of the Infrastructure Ecosystem 1000 of FIG. 3 (e.g., an Infrastructure Cloud platform) designed to predict and synthesize information for generating reports on status, dependency, and action recommendations. The Infrastructure Ecosystem 1000 may receive inputs from the planning and management platform 400 of FIG. 4, an infrastructure ecosystem (block 1010), and other layers (block 1060). The planning and management platform 400 input may represent the first layer of the ecosystem, focusing on planning and project management information. The infrastructure ecosystem input 1010 may encompass platforms across the organization, including cloud and on-premise resources from various cloud provider vendors such as AWS, Google, Azure and/or on-premise resources. This allows for a comprehensive understanding of information coming from the infrastructure ecosystem. The other layers input aids in understanding relationships across different layers of the ecosystem.

The Infrastructure Ecosystem 1000 may use a machine learning (ML) model to predict potential issues, vulnerabilities, or challenges within the infrastructure ecosystem (block 1020). This ML model may leverage training data from Jira, Jira Align, and other planning management tools, as well as logging and monitoring data from infrastructure ecosystem platforms like AWS, Azure, GCP, and on-premise data.

Following the prediction step at block 1020, the Infrastructure Ecosystem 1000 may synthesize tickets and epics using a generative AI model based on the information from the planning and program management tools (block 1030). This step aims to determine if the predicted issues are already being addressed and, if not, what the next action recommendations should be.

The Infrastructure Ecosystem 1000 may apply reinforcement learning with human feedback (RL/HF) to review and refine the action recommendations, dependencies, and status reports generated by the generative AI model (block 1040). This allows for human intervention to review the system's outputs and make necessary adjustments or take actions based on vulnerabilities or dependencies identified by the system.

Finally, the Infrastructure Ecosystem 1000 may generate a report on the status, dependency, and action recommendations for review and action by relevant stakeholders (block 1050). This report may be produced outside the Infrastructure Cloud platform and may include actionable insights based on the synthesized information and human-reviewed recommendations.

In the context of a computing environment, the planning and management platform, infrastructure ecosystem, and other layers inputs may be processed by servers or cloud-based services designed to handle large datasets and complex computations. The ML and generative AI models, along with the RL/HF component, may be executed on specialized computing hardware optimized for machine learning tasks. These components collectively enable the Infrastructure Cloud platform to predict, synthesize, and recommend actions effectively, leveraging the computing environment's capabilities to address the needs of the infrastructure ecosystem comprehensively.

### Block Flow Diagram—Prognosis Console

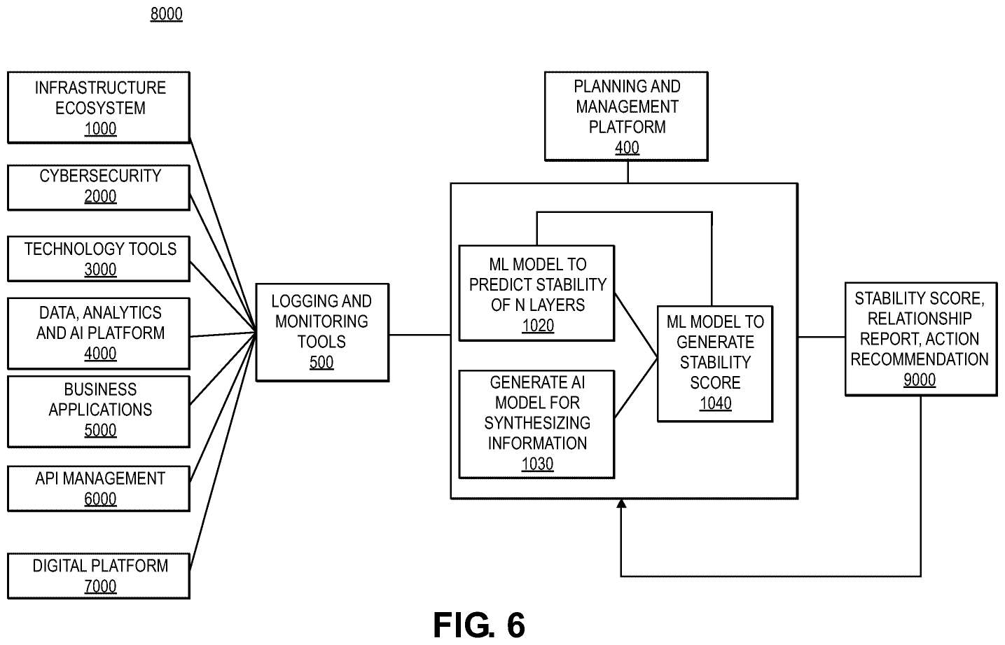

FIG. 6 depicts a block flow diagram for the operation and functionality of the Prognosis Console 8000 within a computing environment. The Prognosis Console 8000 is designed to predict stability, generate stability scores, and provide recommendations based on synthesized information, leveraging machine learning (ML) models and generative AI. This diagram illustrates the integration of various components and processes to enhance system performance monitoring and management.

The Prognosis Console 8000 receive inputs from the planning and management platform 400. This involves gathering planning and management information, which serves as a foundational input for the subsequent processes within the Prognosis Console. The planning and management platform may be executed on a central processing unit within a computing environment, coordinating the overall strategy and objectives for system stability and performance.

The Prognosis Console 8000 may use a machine learning model to predict the stability of one or more layers (block 1020). This step involves analyzing data from various sources, including logging and monitoring tools, to assess the stability across different infrastructure and application layers. The ML model for predicting stability can be run on dedicated machine learning servers or cloud-based AI services within the computing environment, utilizing historical and real-time data to make predictions.

The Prognosis Console 800 may employ another machine learning model to generate a stability score (block 1040). This model may process the predictive data from the previous step (block 1020) and assign a stability score, indicating the overall health and stability of the system. This process can be performed by AI processing units or cloud-based machine learning services, which analyze the predictive outcomes and synthesize them into a comprehensive stability score.

The Prognosis Console 800 may synthesize information using a generative AI model (block 1030). This step may include integrating and interpreting data from the stability prediction and scoring models to generate detailed reports, resolution recommendations, and action plans. The generative AI model can be hosted on AI-enhanced servers or cloud platforms, leveraging advanced algorithms to create understandable and actionable insights from complex data sets.

The Prognosis Console 800 may output stability scores, resolution reports, and action recommendations (block 9000). This may include presenting the synthesized information in a user-friendly format, such as dashboards or reports, which can be accessed through user interfaces on computing devices. The output can also include alerts and notifications sent to project or program owners (e.g., via text message, email, etc.), facilitating immediate action on identified issues.

The Prognosis Console 800 may receive inputs from logging and monitoring tools (block 500) and continuously and/or periodically integrate those inputs, capturing changes and triggering updates across the system. These tools may be part of the computing environment's infrastructure, monitoring the performance and health of various components, including the infrastructure ecosystem (block 1000), cybersecurity measures (block 2000), technology tools (block 3000), data analytics and AI platforms (block 4000), business applications (block 5000), API management systems (block 6000), and digital platforms (block 7000). The feedback loop from these tools enables the Prognosis Console 8000 to adapt and learn over time, advantageously enhancing its predictive accuracy and recommendation effectiveness.

The computing environment supporting the Prognosis Console may include a combination of physical servers, cloud computing resources, dedicated AI processing units, and data storage systems. These components work together to execute the machine learning models, generative AI algorithms, and data analysis processes that underpin the functionality of the Prognosis Console.

### Block Flow Diagram—Action Board

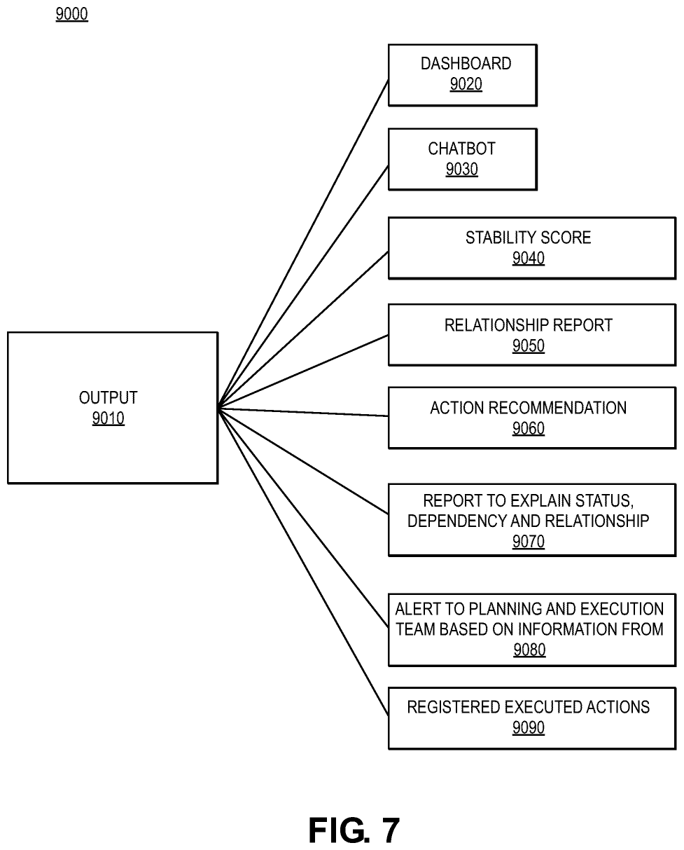

FIG. 7 depicts a block flow diagram for generating various output components of an Action Board (e.g., the Action Board 9000 of FIG. 6). The Action Board 9000 may generate a central output (block 9010). The Action Board 9000 may generate a dashboard as an output component of the Action Board (block 9020). The Action Board 9000 may generate a chatbot as an output component of the Action Board (block 9030). The Action Board 9000 may generate a stability score as an output component of the Action Board (block 9040). The Action Board 9000 may generate a relationship report as an output component of the Action Board (block 9050). The Action Board 9000 may generate an action recommendation as an output component of the Action Board (block 9060). The Action Board 9000 may generate a report to explain status, dependency, and relationship as an output component of the Action Board (block 9070). The Action Board 9000 may generate an alert to the planning and execution team based on information from the Action Board (block 9080). The Action Board 9000 may generate registered executed actions as an output component of the Action Board (block 9090).

In a computing environment, the central output (block 9010) may be generated by a central processing unit or a server that coordinates the overall functionality of the Action Board. The dashboard (block 9020) may be rendered by a user interface processing module, designed to provide a visual summary of key information. The chatbot (block 9030) may be managed by a natural language processing module, allowing for interactive communication with users. The stability score (block 9040) may be calculated by an analytics module, assessing various factors to provide a quantifiable measure of stability (e.g., the update module 120 of FIG. 1). The relationship report (block 9050) might be generated by a data analysis module, which processes data to identify and report on relationships between different entities or variables. The action recommendation (block 9060) could be produced by a recommendation engine, which analyzes data to suggest next steps. The report to explain status, dependency, and relationship (block 9070) may also be generated by the data analysis module, providing detailed insights into the current state, dependencies, and relationships within the system. The alert to the planning and execution team (block 9080) could be managed by an alerting module, which monitors the system and sends notifications based on specific criteria (e.g., the module 124 of FIG. 1). Finally, the registered executed actions (block 9090) may be recorded by a transaction logging module, keeping track of actions that have been taken. Any of these modules may be integrated into the modules depicted in the memory 104 of FIG. 1, as additional or substitute models for the existing modules. In some aspects, the existing modules may be modified to add functionality to support additional features.

### Block Flow Diagram—Exemplary Computing Architecture

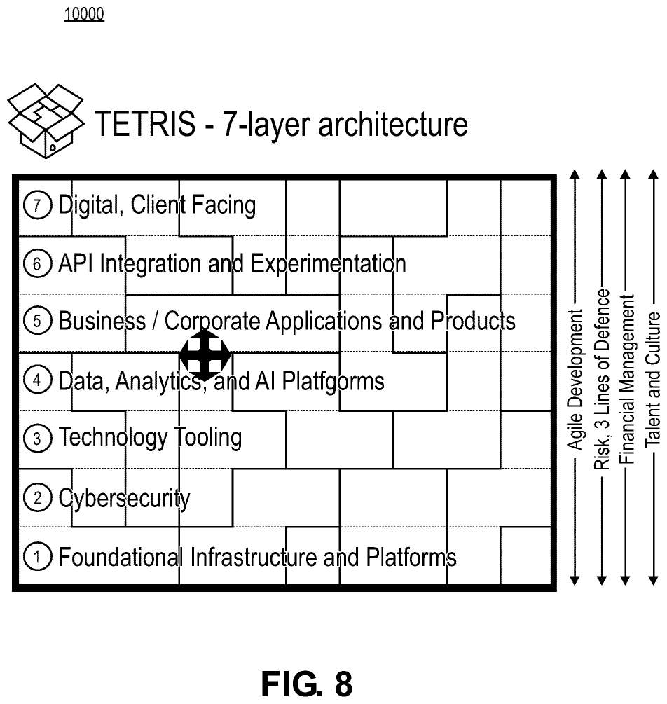

FIG. 8 depicts a block flow diagram of an exemplary architectural diagram depicting a computing architecture 10000, or technology stack, for enhancing organizational efficiency and transparency across a multi-layered technology ecosystem. The computing architecture 10000 may correspond to the enterprise technology ecosystem layers 170 of FIG. 1. The computing architecture 10000 may include a foundational infrastructure and platforms as a base layer. This foundational layer may support one or more other layers and may include the infrastructure cloud platform, serving as the bedrock for the entire technology ecosystem. The computing environment responsible for this aspect may include physical servers, virtualization platforms, and cloud infrastructure services that provide the necessary computational resources and foundational support for higher-level services and applications.

The computing architecture 10000 may integrate cybersecurity measures across all layers of the technology stack, ensuring secure-by-design principles are embedded within each layer, including the foundational infrastructure and platforms. For example, the computing environment of FIG. 1 may leverage security appliances, firewalls, intrusion detection systems, and security information and event management (SIEM) systems to implement these cybersecurity measures effectively.

The computing architecture 10000 may include deploying technology tooling across the ecosystem, encompassing DevSecOps, continuous integration and continuous deployment (CICD) tooling, and IT asset management. The computing environment of FIG. 1, for example, may utilize various software development tools, automation platforms, and asset management solutions to facilitate efficient development practices and resource management.

The computing architecture 10000 may establish a data, analytics, and AI platform layer to support data-powered initiatives and insights. This involves the computing environment employing data storage solutions, analytics platforms, and artificial intelligence models to process and analyze data, driving informed decision-making and innovation.

The computing architecture 10000 may include incorporating business/corporate applications and products to address specific organizational needs and objectives (block 610). The computing environment may include enterprise resource planning (ERP) systems, customer relationship management (CRM) software, and other application platforms that support business operations and corporate functions.

The computing architecture 10000 may include an API integration and experimentation layer to facilitate API-driven interactions and integrations within the ecosystem. The computing environment of FIG. 1 may use API management platforms and middleware solutions to enable seamless communication between different systems, services, and applications.

The computing architecture 10000 may include digital, client-facing solutions to prioritize a digital-first approach, including web and mobile applications. The computing environment may leverage web servers, application development frameworks, and mobile development platforms to create user-centric digital experiences. The computing environment of FIG. 1 may collect data from all layers of the technology ecosystem to provide visibility and transparency regarding dependencies, relationships, and the status of work across the technical ecosystem. This involves the computing environment utilizing event-based systems and real-time data processing to aggregate and analyze information from various sources, enabling teams across the organization to prioritize work and address interdependencies effectively.

The computing architecture 10000 may implement both proactive and reactive measures based on the collected data to address errors, issues, and remediation needs across the technology ecosystem. For example, as discussed above, the computing environment of FIG. 1 may employ automated remediation tools, recommendation engines, and human-in-the-loop review processes to ensure timely and effective responses to identified challenges, thereby reducing technical debt and enhancing overall organizational efficiency.

### Aspects

The various embodiments described above can be combined to provide further embodiments. All U.S. patents, U.S. patent application publications, U.S. patent application, foreign patents, foreign patent application and non-patent publications referred to in this specification and/or listed in the Application Data Sheet are incorporated herein by reference, in their entirety. Aspects of the embodiments can be modified if necessary to employ concepts of the various patents, applications, and publications to provide yet further embodiments.

These and other changes can be made to the embodiments in light of the above-detailed description. In general, in the following claims, the terms used should not be construed to limit the claims to the specific embodiments disclosed in the specification and the claims but should be construed to include all possible embodiments along with the full scope of equivalents to which such claims are entitled. Accordingly, the claims are not limited by the disclosure.

Aspects of the techniques described in the present disclosure may include any of the following aspects, either alone or in combination:
1. A computing system comprising: a processor; and a memory having stored thereon computer-executable instructions that, when executed, cause the computing system to: collect data from one or more layers of an enterprise technology ecosystem; process the collected data using artificial intelligence to generate relationships and predict stability across the layers; identify one or more dependencies; and generate actionable tasks to optimize processes, wherein the system updates sources in real-time based on event-triggered updates and maintains equilibrium across all layers by recommending actionable tasks to maintain said equilibrium.
2. The computing system of aspect 1, the memory having stored thereon computer-executable instructions that, when executed, cause the computing system to: trigger alerts to a planning and execution team for each layer when actionable tasks are identified.
3. The computing system of any of aspects 1-2, the memory having stored thereon computer-executable instructions that, when executed, cause the computing system to: operate autonomously, taking proactive, reactive, and prescriptive actions to prevent issues and maintain system equilibrium.
4. The computing system of any of aspects 1-3, the memory having stored thereon computer-executable instructions that, when executed, cause the computing system to: incorporate feedback from users on automated actions taken, for use in subsequent cycles of operation.
5. The computing system of any of aspects 1-4, the memory having stored thereon computer-executable instructions that, when executed, cause the computing system to: generate a dependency map that includes service level agreements (SLAs) for various components of the technology ecosystem.
6. The computing system of any of aspects 1-5, the memory having stored thereon computer-executable instructions that, when executed, cause the computing system to: interact with infrastructure ecosystems including cloud, hybrid, and any device connected to other platforms.
7. The computing system of any of aspects 1-6, the memory having stored thereon computer-executable instructions that, when executed, cause the computing system to: integrate with management platforms for agile project management.
8. A computer-readable medium having stored thereon a set of executable instructions that, when executed, cause a computer to: collect data from one or more layers of an enterprise technology ecosystem; process the collected data using artificial intelligence to generate relationships and predict stability across the layers; identify one or more dependencies; and generate actionable tasks to optimize processes, wherein the computer updates sources in real-time based on event-triggered updates and maintains equilibrium across all layers by recommending actionable tasks to maintain said equilibrium.
9. The computer-readable medium of aspect 8, having stored thereon a set of executable instructions that, when executed, cause a computer to: trigger alerts to a planning and execution team for each layer when actionable tasks are identified.
10. The computer-readable medium of any of aspects 8-9, having stored thereon a set of executable instructions that, when executed, cause a computer to: operate autonomously, taking proactive, reactive, and prescriptive actions to prevent issues and maintain system equilibrium.
11. The computer-readable medium of any of aspects 8-10, having stored thereon a set of executable instructions that, when executed, cause a computer to: incorporate feedback from users on automated actions taken, for use in subsequent cycles of operation.
12. The computer-readable medium of any of aspects 8-11, having stored thereon a set of executable instructions that, when executed, cause a computer to: generate a dependency map that includes service level agreements (SLAs) for various components of the technology ecosystem.
13. The computer-readable medium of any of aspects 8-12, having stored thereon a set of executable instructions that, when executed, cause a computer to: interact with infrastructure ecosystems including cloud, hybrid, and any device connected to other platforms.
14. The computer-readable medium of any of aspects 8-13, having stored thereon a set of executable instructions that, when executed, cause a computer to: integrate with management platforms for agile project management.
15. A computer-implemented method for optimizing enterprise technology ecosystems, comprising: collecting data from one or more layers of an enterprise technology ecosystem; processing the collected data using artificial intelligence to generate relationships and predict stability across the layers; identifying one or more dependencies; and generating actionable tasks to optimize processes, wherein the method updates sources in real-time based on event-triggered updates and maintains equilibrium across all layers by recommending actionable tasks to maintain said equilibrium.
16. The computer-implemented method of aspect 15, further comprising: triggering alerts to a planning and execution team for each layer when actionable tasks are identified.
17. The computer-implemented method of any of aspects 15-16, further comprising: operating autonomously, taking proactive, reactive, and prescriptive actions to prevent issues and maintain system equilibrium.
18. The computer-implemented method of any of aspects 15-17, further comprising: incorporating feedback from users on automated actions taken, for use in subsequent cycles of operation.
19. The computer-implemented method of any of aspects 15-18, further comprising: generating a dependency map that includes service level agreements (SLAs) for various components of the technology ecosystem.
20. The computer-implemented method of any of aspects 15-19, further comprising: interacting with infrastructure ecosystems including cloud, hybrid, and any device connected to other platforms.

### Additional Considerations

The following considerations also apply to the foregoing discussion. Throughout this specification, plural instances may implement operations or structures described as a single instance. Although individual operations of one or more methods are illustrated and described as separate operations, one or more of the individual operations may be performed concurrently, and nothing requires that the operations be performed in the order illustrated. These and other variations, modifications, additions, and improvements fall within the scope of the subject matter herein.

It should also be understood that, unless a term is expressly defined in this patent using the sentence “As used herein, the term” “is hereby defined to mean . . . ” or a similar sentence, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to in this patent in a manner consistent with a single meaning, that is done for sake of clarity only so as to not confuse the reader, and it is not intended that such claim term be limited, by implication or otherwise, to that single meaning. Finally, unless a claim element is defined by reciting the word “means” and a function without the recital of any structure, it is not intended that the scope of any claim element be interpreted based on the application of 35 U.S.C. § 112(f).

Unless specifically stated otherwise, discussions herein using words such as “processing,” “computing,” “calculating,” “determining,” “presenting,” “displaying,” or the like may refer to actions or processes of a machine (e.g., a computer) that manipulates or transforms data represented as physical (e.g., electronic, magnetic, or optical) quantities within one or more memories (e.g., volatile memory, non-volatile memory, or a combination thereof), registers, or other machine components that receive, store, transmit, or display information.

As used herein any reference to “one embodiment” or “an embodiment” means that a particular element, feature, structure, or characteristic described in connection with the embodiment is included in at least one embodiment. The appearances of the phrase “in one embodiment” in various places in the specification are not necessarily all referring to the same embodiment.

As used herein, the terms “comprises,” “comprising,” “includes,” “including,” “has,” “having” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive or and not to an exclusive or. For example, a condition A or B is satisfied by any one of the following: A is true (or present) and B is false (or not present), A is false (or not present) and B is true (or present), and both A and B are true (or present).

In addition, use of “a” or “an” is employed to describe elements and components of the embodiments herein. This is done merely for convenience and to give a general sense of the invention. This description should be read to include one or at least one and the singular also includes the plural unless it is obvious that it is meant otherwise.

Upon reading this disclosure, those of skill in the art will appreciate still additional alternative structural and functional designs for implementing the concepts disclosed herein, through the principles disclosed herein. Thus, while particular embodiments and applications have been illustrated and described, it is to be understood that the disclosed embodiments are not limited to the precise construction and components disclosed herein. Various modifications, changes and variations, which will be apparent to those skilled in the art, may be made in the arrangement, operation and details of the method and apparatus disclosed herein without departing from the spirit and scope defined in the appended claims.

What is claimed is:

1. A computing system comprising:
a processor; and
a memory having stored thereon computer-executable instructions that, when executed, cause the computing system to:
collect data from one or more layers of an enterprise technology ecosystem;
process the collected data using artificial intelligence to generate relationships and predict stability across the layers;
identify one or more dependencies; and
generate actionable tasks to optimize processes,
wherein the system updates sources in real-time based on event-triggered updates and maintains equilibrium across all layers by recommending actionable tasks to maintain said equilibrium.

2. The computing system of claim 1, the memory having stored thereon computer-executable instructions that, when executed, cause the computing system to:
trigger alerts to a planning and execution team for each layer when actionable tasks are identified.

3. The computing system of claim 1, the memory having stored thereon computer-executable instructions that, when executed, cause the computing system to:
operate autonomously, taking proactive, reactive, and prescriptive actions to prevent issues and maintain system equilibrium.

4. The computing system of claim 1, the memory having stored thereon computer-executable instructions that, when executed, cause the computing system to:
incorporate feedback from users on automated actions taken, for use in subsequent cycles of operation.

5. The computing system of claim 1, the memory having stored thereon computer-executable instructions that, when executed, cause the computing system to:
generate a dependency map that includes service level agreements (SLAs) for various components of the technology ecosystem.

6. The computing system of claim 1, the memory having stored thereon computer-executable instructions that, when executed, cause the computing system to:
interact with infrastructure ecosystems including cloud, hybrid, and any device connected to other platforms.

7. The computing system of claim 1, the memory having stored thereon computer-executable instructions that, when executed, cause the computing system to:
integrate with management platforms for agile project management.

8. A computer-readable medium having stored thereon a set of executable instructions that, when executed, cause a computer to:
collect data from one or more layers of an enterprise technology ecosystem;
process the collected data using artificial intelligence to generate relationships and predict stability across the layers;
identify one or more dependencies; and
generate actionable tasks to optimize processes,
wherein the computer updates sources in real-time based on event-triggered updates and maintains equilibrium across all layers by recommending actionable tasks to maintain said equilibrium.

9. The computer-readable medium of claim 8, having stored thereon a set of executable instructions that, when executed, cause a computer to:
trigger alerts to a planning and execution team for each layer when actionable tasks are identified.

10. The computer-readable medium of claim 8, having stored thereon a set of executable instructions that, when executed, cause a computer to:
operate autonomously, taking proactive, reactive, and prescriptive actions to prevent issues and maintain system equilibrium.

11. The computer-readable medium of claim 8, having stored thereon a set of executable instructions that, when executed, cause a computer to:
incorporate feedback from users on automated actions taken, for use in subsequent cycles of operation.

12. The computer-readable medium of claim 8, having stored thereon a set of executable instructions that, when executed, cause a computer to:
generate a dependency map that includes service level agreements (SLAs) for various components of the technology ecosystem.

13. The computer-readable medium of claim 8, having stored thereon a set of executable instructions that, when executed, cause a computer to:
interact with infrastructure ecosystems including cloud, hybrid, and any device connected to other platforms.

14. The computer-readable medium of claim 8, having stored thereon a set of executable instructions that, when executed, cause a computer to:
integrate with management platforms for agile project management.

15. A computer-implemented method for optimizing enterprise technology ecosystems, comprising:
collecting data from one or more layers of an enterprise technology ecosystem;
processing the collected data using artificial intelligence to generate relationships and predict stability across the layers;
identifying one or more dependencies; and
generating actionable tasks to optimize processes,
wherein the method updates sources in real-time based on event-triggered updates and maintains equilibrium across all layers by recommending actionable tasks to maintain said equilibrium.

16. The computer-implemented method of claim 15, further comprising:
triggering alerts to a planning and execution team for each layer when actionable tasks are identified.

17. The computer-implemented method of claim 15, further comprising:
operating autonomously, taking proactive, reactive, and prescriptive actions to prevent issues and maintain system equilibrium.

18. The computer-implemented method of claim 15, further comprising:
incorporating feedback from users on automated actions taken, for use in subsequent cycles of operation.

19. The computer-implemented method of claim 15, further comprising:
generating a dependency map that includes service level agreements (SLAs) for various components of the technology ecosystem.

20. The computer-implemented method of claim 15, further comprising:
interacting with infrastructure ecosystems including cloud, hybrid, and any device connected to other platforms.
